(19) United States
(12) Patent Application Publication
(10) Pub. No.: US 2018/0267518 A1
(43) Pub. Date: Sep. 20, 2018

(54) SYSTEM AND METHOD OF REMOTE RAPID MANUFACTURING USING DISTRIBUTED, REAL TIME, AGGREGATED RESOURCES

(71) Applicant: Forgge, Inc., Greenville, SC (US)

(72) Inventor: Eric Hassman, Piedmont, SC (US)

(73) Assignee: Forgge, Inc., Greenville, SC (US)

(21) Appl. No.: 15/925,003

(22) Filed: Mar. 19, 2018

Related U.S. Application Data
(60) Provisional application No. 62/473,343, filed on Mar. 18, 2017.

(51) Int. Cl. G05B 19/418; G06Q 10/08; B29C 64/393; B33Y 50/02

(52) U.S. Cl. CPC G05B 19/41865; G05B 19/4183; G05B 19/41845; B33Y 50/02; G06Q 10/087; B29C 64/393; G06Q 10/083

(57) ABSTRACT

This invention is a system for aggregating disparate remote rapid manufacturing resources for fulfillment of manufactured parts comprising: a set of user computer readable instructions executed on the user computer system for receiving a part. A server can be in communications with a manufacturing system or manufacturing machine. The server instructions can receive the part request, determine if the part request is accompanied by a digital part file, request a digital part file, receive manufacturing machine status information from a dynamic queue of available manufacturing machines, transmit manufacturing machine status information to a user, receive an order confirmation, transmit the order confirmation, receive confirmation that the part has been manufactured and ship the manufactured part to the user.

### BACKGROUND OF THE INVENTION

### (1) Field of the Invention

This invention is in the field of rapid manufacturing and more specifically, the field of facilitating remote manufacturing where fulfillment uses distributed, real time, aggregated resources such as third party 3D printers, laser cutters, CNC machines, plasma cutters, lathes, and the like where the resources are selected based upon real time selection criteria to optimize delivery time, financial impact, quality, and minimize risk.

### (2) Description of the Related Art

As manufacturing and information technology develop, especially with the use of advanced materials, there are currently significant hurdles, inefficiencies, and complexities involved with having end goods actually manufactured. For example, with the growth of third dimensional (3D) printing or additive manufacturing, the materials used now vary greatly and include plastics, metals, charged plastics, resins, multicolored materials, and ceramics. Even within these broad categories, there are a multitude of materials that can be used, each with unique and sometimes mutually exclusive properties. For example, plastics can involve polyamide, acrylonitrile butadiene styrene, polycarbonate acrylonitrile butadiene styrene, any number of amorphous thermoplastic polyetherimides, polyhet photopolymers, polylactic acid, polyethylene terephthalate, high impact polystyrene, and many others.

These materials also have a very wide range of physical properties that are used to determine the optimal material for manufacturing a part. The physical properties can include color, tensile strength, impact strength, rupture strength, melting point, grade, elongation at break, strength to weight ratio, temperature resistance, corrosion resistance, fatigue, creep, hardness, resiliency, biocompatibility, yield strength, heat deflection, stiffness, moisture absorption, translucency, tensile modulus, flexural modulus, cure and post-cure processes, weight, water resistance, resolution, and the like. There are also practical implications when selecting a material that include costs, availability of the material, and the availability of the actual manufacturing machine itself. For example, based upon the materiel selected and physical properties desired, the 3D machine that is used would be selected from the general groups of stereolithography, digital light processing, fused deposition modeling, selective laser sintering, selective laser melting, electronic beam melting, and laminated object manufacturing.

As for material costs, these can range from inexpensive to even cost prohibitive. For example, 2.5 kg of a 3 mm polylactic acid in white filament may cost about $52.00 (US) while 2.5 kg of a 3.00 mm acrylonitrile butadiene styrene in white may cost about $105.00 (US). As for metal, usually powdered, platinum can be $1750.00/cm², 14K gold can be $600.00/cm², with aluminum currently costing about $7.00/cm² and steel costing about $5.00/cm². Further, storage of certain materials can be hazardous. When storing and handling powdered metals, such as those used for some 3D printing, a high surface-to-volume ratio exists and coupled with the reactive nature of these metals, powder explosions are unfortunately a regular occurrence internationally that can result in serious injury and loss of life. These physical properties, handling risks, and costs affect the amount of raw material that would be stored for use given that the more expensive the costs, the lower the demand for the material and the higher the risk, the least likely that any given manufacturer would have sufficient quantities of the material on hand for a given project.

These disadvantages of costs and handling risk are not limited to the 3D printing industry. For computer numerical control (CNC) manufacturing, materials can include extruded polystyrene, extruded polyurethane, plywood, medium density fiberboard, solid wood, carbon plates, hard plastics, polyvinyl chloride, plexiglas, and a side varied to metals. Polystyrene contains the toxic substances styrene and benzene that are suspected carcinogens and neurotoxins and hazardous to humans. When a CNC operates on polystyrene, hot wires can be used and potentially case the release of styrene monomers, a compound hazardous to humans. Plasma cutting is used for steel, aluminum, brass, copper, and any other conductive metal. When in operation, a plasma cutter can create hexavalent chromium in vapor form which causes cancer in the human body. Chronic inhalation of hexavalent chromium has been shown to increase the percentage of lung cancer and can also damage the kidneys and intestines. Plasma dust is also created that is very harmful to humans. These risks limit the number of manufactures that will provide plasma cutting services.

In addition, there are the machines themselves and the operations based upon the different materials. Machines are selected based upon many factors including materials, build volume size, print quality, type, layer thickness (min. and max.), printing speed, resolution, connectivity, and others. Based upon the machine type, costs for commercial machines range from around $10,000 to over $1,000,000. Given the multitude of options and factors including machine costs, machine parameters, materials, risks and even floor space, manufacturers have to be fairly selective on the type, quality, and quantity of manufacturing machines that are purchased. Therefore, it is unlikely that any one single manufacturer can satisfy the needs of each customer requiring manufacturing services. Further, if every manufacturer decided to purchase a very wide variety of manufacturing machines in stock raw material, these machines can become obsolete within a very short period of time.

Traditionally, the user that wishes to have a part manufactured from a specification such as computer aided design (CAD) drawings, must perform research on potential manufacturers, contact the manufacturers, gather selection criteria from the manufacturer, and make a selection. When this process is completed, the information that was provided by the manufacturer can have changed so that the selected manufacturer no longer is able to make the part. For example, the manufacturing machine is being used for another job, the inventory of materials is depleted, or the price changes. In this case, the user must repeat the process adding unnecessary delay to the manufacture of the part. In some cases, this delay increases costs as the user must purchase expedited services.

Additionally, there is the post-manufacturing process that is often overlooked in the art. Once a part is manufactured through 3D printing, CNC, or the like, there are finishing and post-production processes such as welding, drilling, heating, reworking, trimming, grooving, sanding, polishing, filling, painting, sealing, gluing, and the like. These processes are often not performed by the manufacturer and the user only learns of this need once the part is produced and delivered to the user. Again, unnecessary time and cost are incurred due to the lack of the manufacturer to provide these services.

Attempts have been made to assist users with the selection of a manufacturer in the 3D printing industry such as U.S. Pat. No. 9,229,674 directed to a system, method, and media for optimizing and facilitating 3D printing services in a marketplace environment using memory and at least one module, executing on one or more computer processors, to host or participate in a 3D printing service marketplace environment including marketplace participants and a federated network of 3D printing service providers. However, this reference simply does not consider the practical ability of the 3D printer to make the part based upon the availability of the 3D printer itself, the inventory of raw materials and other practical considerations. Therefore, the invention of this reference does not address the concerns listed above and may require the user to waste unnecessary time and energy determining the practical ability of the manufacturer to produce the part.

One attempt to simplify the process of selecting a 3D printer has been disclosed in United States Patent Application Publication 2014/0279177 that is directed to a system and method for providing price quotes for 3D objects are described herein. In one embodiment, costs related to generating a 3D object molded from a 3D printer mold may be based on various parameters. U.S. Pat. No. 8,412,588 discloses a system and method provided for fabricating products on demand. In this reference, a prototype of the product can be generated based on a model. The product may be fabricated based at least in part on the model using, for example, a three-dimensional printer, and may be delivered to users of the electronic system. These references assume that the manufacturer can make the model. None of these references address the practical ability of the manufacturer to actually make the part.

Further, none of these references address the ability of the user to select a manufacturer based upon post-manufacturing processes such as finishing and post-processing. Further, none of these references provide pre-production processes for optimizing the manufacturing specifications based upon the user's supplier design.

Therefore, it is an object of the present invention to provide for a system and method of allowing a user to select remote rapid manufacturers from a distributed, real time, aggregated set of manufacturers.

It is another object of the present invention to select manufacturers based upon criteria including the availability of the manufacturing machine, availability of raw materials, and provisioning of post-manufacturing processes and services.

It is another object of the present invention to select manufacturers based upon third party customer's review, past history, and scoring.

It is another object of the present invention to provide for pre-production analysis of the design to optimize the manufacturing for the user.

### SUMMARY OF THE INVENTION

The above objectives are accomplished according to the present invention by providing a computer implemented system comprising: a server in electronic communications with a user device, manufacturer information system, manufacturing machine(s), database(s) of digital part files, financial computer system, and shipping computer system; a preprocessor and computer readable medium included in the server; and, a set of computer readable instructions included in the computer readable medium for performing one or more of the following functions when executed by the processor: receiving desired part information from the user device, determining if a digital part file is available, scanning a physical part resulting in a digital part file, selecting a digital part file from a database, modifying a digital part file, analyzing the digital part file for manufacturing conformity, searching for suitable manufacturer according to user information received, and a dynamic, real time, aggregated database of manufacturers, receiving search results, displaying search results, managing a financial transaction for a user selected manufacturer, making a part, post-processing the part, shipping the part to a user or user's customer, and receiving and providing rating information from the transaction received from the user, user's customer, manufacturer or shipper.

The invention can include a system for aggregating disparate remote rapid manufacturing resources for fulfillment of manufactured parts comprising: a user computer system in communications with a server; a set of user computer readable instructions executed on the user computer system for receiving a part request from a group consisting of an individual, a procurement system, an ordering system or any combination thereof; translating the part request into a syntax usable by a set of server computer readable instructions; and receiving order status information from the set of service computer readable instructions representing that the requested part can be made; a server in communications with a manufacturing system and a shipping system; and, the set of server computer readable instructions executed on the server that can receive the part request from the user computer system, determine if the part request is accompanied by a digital part file, if not request a digital part file from a set of digital part files and receive the digital part file from the set of digital part files, receive manufacturing machine status information from a dynamic queue of available manufacturing machines suitable to make the requested part and representing the ability to physically make the requested part according to part request, transmit the manufacturing machine status information to the user computer system for displaying the status information to the user, receive an order confirmation from the user computer system according to the manufacturing machine status information, transmit the order confirmation to the manufacturing system, receive confirmation that the part has been manufactured from the manufacturing system, transmit shipping information to a shipping system representing logistics information for shipping the part to user and transmit the shipping information to the manufacturing system so that the manufactured part can be shipped to the user.

The manufacturing machine can be in communications with the server and includes a set of manufacturing computer readable instructions that periodically transmits the manufacturing machine status information of the manufacturing machine to the server. The set of manufacturing computer readable instructions can include instructions that transmits a further forecast of the manufacturing machine representing when in the future the manufacturing machine will be able to make the requested part. The set of server computer readable instructions include instructions for receiving the manufacturing machine status information from the manufacturing machine and translating a manufacturing machine syntax of the manufacturing machine status information to a server syntax.

The invention can include a manufacturing server having manufacturing computer readable instructions; the set of server computer readable instructions can include instructions for transmitting a reservation request to a manufacturing server representing that one manufacturing machines associated with the manufacturing server is a candidate to receive an order confirmation; and, the manufacturing computer readable instructions includes instructions preventing an additional manufacturing job from being assigned to the manufacturing machine for a predetermined period of time.

The set of server computer readable instructions includes instructions for transmitting to the manufacturing server release instructions representing that the manufacturing machine was not selected for the manufacturing the requested part and can be released to perform an additional job. The dynamic queue can receive manufacturing machine status information in real-time and the set of server computer readable instructions transmits to the user computer system the manufacturing machine status information in real-time. The manufacturing machine status information includes an engage time representing the time in which the manufacturing machine will be available to make the requested part.

The server computer readable instructions can include instructions for transmitting an order confirmation time representing the time limit in which the user can select the manufacturing machine and the order confirmation time is less than the engage time. The set of server computer readable instructions include instruction for determine if the digital part file selected to make the requested part is capable of being used by the manufacturing machine, and if not, generating error correction information representing proposed correction to the digital part file and transmitting the error correction information to the user computer system.

The set of user computer readable instructions executed on the user computer system for receiving a part request; receiving order status information from a set of server computer readable instructions representing that the requested part can be made; a server in communications with a manufacturing system and a shipping system; and, the set of server computer readable instructions, executed on the server, includes instructions that can receive a part request from the user computer system, determine if the part request is accompanied by a digital part file, if not request a digital part file from a set of digital part files and receive the digital part file from the set of digital part files, receive manufacturing machine status information from a dynamic queue of available manufacturing machines suitable to make the requested part and representing the ability to physically make the requested part according to part request, transmit the manufacturing machine status information to the user computer system for displaying the status information to the user, receive an order confirmation from the user computer system according to the manufacturing machine status information, transmit the order confirmation to the manufacturing machine, receiving confirmation that the part has been manufactured from the manufacturing machine, transmit shipping information to a shipping system representing logistical information to ship the part to user and transmit the shipping information to the manufacturing machine so that the manufactured part can be shipped to the user.

The invention can include a procurement system having procurement computer readable instructions for determining if the number of parts in an inventory drops below a predetermine level and if so, automatically sending an order result to the server, receiving receive manufacturing machine status information, selecting a manufacturing machines according to the manufacturing machine status information and transmitted an order confirmation to the server. The procurement computer readable instructions include instructions for updating a set of properties associated with the manufacturing machine selected.

The invention can include an ordering system having ordering computer readable instructions for receiving a part request from a user, receiving manufacturing machine status information, selecting a manufacturing machine according to the manufacturing machine status information and transmitted an order confirmation to the server so that the manufacturing machine can be instructed to manufacturer the part. The ordering computer readable instructions include instructions for displaying to the user to period of time that the manufacturing machines are available for making the requested part. The ordering computer readable instructions includes instructions for aggregating part requests and transmit the aggregated parts requests to a particular manufacturing machine according to the manufacturing machine's machine properties.

The invention can include a server in communications with a manufacturing machine; and, the set of server computer readable instructions, executed on the server, includes instructions that can receive a part request from a user computer system, receive manufacturing machine status information from a dynamic queue of available manufacturing machines suitable to make the requested part, transmit the manufacturing machine status information to the user computer system, receive an order confirmation from the user computer system, transmit the order confirmation to the manufacturing machine, and receiving confirmation that the part has been manufactured from the manufacturing machine. The set of manufacturing computer readable instructions that, when executed by the manufacturing machine, periodically transmit manufacturing machine status information to the server. The set of manufacturing computer readable instructions includes instructions that transmits a further forecast of the manufacturing machine to be able to make the requested part. The set of server computer readable instructions includes instructions for aggregating part requests and transmitting the aggregated parts requests to a particular manufacturing machine according to the manufacturing machine's machine properties.

### BRIEF DESCRIPTION OF THE DRAWINGS

Various aspects of the disclosure and many of the attendant advantages will become more readily appreciated as the same become better understood by reference to the following detailed description, when taken in conjunction with the accompanying drawings.

FIG. 1 is a schematic of aspects of the invention;

FIGS. 2A and 2B are flowcharts of aspects of the invention;

FIG. 3 is a schematic of aspects of the invention;

FIG. 4 is a schematic of aspects of the invention; and,

FIG. 5 is a schematic of the invention.

### DETAILED DESCRIPTION OF A PREFERRED EMBODIMENT

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques have not been shown in detail.

For this invention, the computer readable instructions of computers and servers interact with physical components to operate on and produce tangible components. The interaction of the invention global communications for remote physical machines to provide a desired result that is both a significant improvement in the information technology itself and in the field of rapid manufacturing. The invention is directed to a specific implementation of a solution to a problem in both information technology itself and in the field of rapid manufacturing.

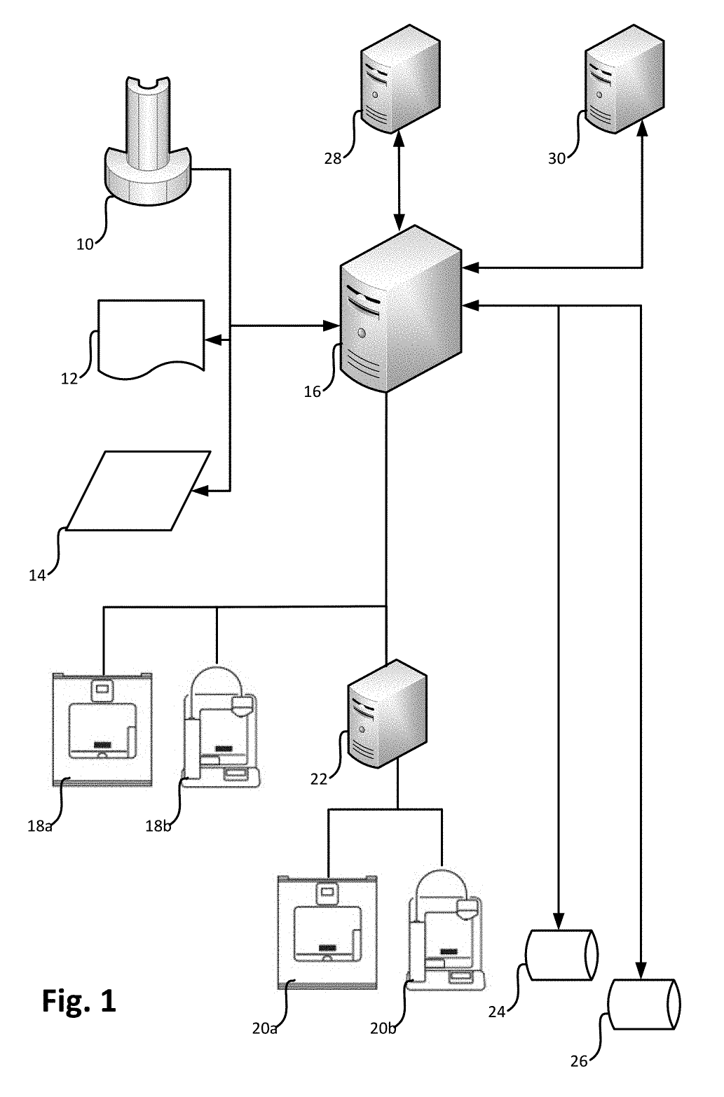

With reference to the drawings, the invention will now be described in more detail. Referring to FIG. 1, a user has a part that the user wishes to have manufactured. The user can select a digital representation of the part from a database 10 that can contain digital files such as shape files and the like. In one configuration, user interface computer readable instructions can include a user interface that can communicate with a local or remote database that can contain digital representations of parts to be manufactured. In the case where the database is remote, a third party can provide publicly available files. The user computer readable instructions can receive the part information from the user and automatically search remote databases to determine if the digital representation of the part is available on a remote database. If so, the user computer readable instructions can translate the part search request to the native format of the particular remote database. The user computer readable instructions can access a table, list, lookup table, or source database can include the potential remote databases to search and the translation information so that adding another remote database that can be searched does not require modifications to the user computer readable instructions, but can be accomplished with an additional entry to the table, list, lookup table, or source database.

In one configuration, the user computer readable instructions can request and receive a digital representation of a part that is similar to the requested part, but not necessarily identical. The user can receive the digital information and modify the digital information to more closely match the requested part. The modified file can be stored for subsequent retrieval by the user and can be transmitted to a remote database for other users to access.

In one configuration, ordering computer readable instructions can be in communications with a procurement system such as an enterprise resource planning (ERP) system, inventory management system, or other such ordering system. The ordering computer readable instructions can receive ordering instructions from the procurement system, such as when inventory levels drop to a predetermined minimum level, in response to forecasts for the need of parts, in response to an order, or the like. The ordering computer readable instructions can be idle under the procurement system, request a part, or can periodically poll the ordering system. The ordering computer readable instructions can transmit manufacturing status information to the ordering system to allow user of the ordering system review manufacturing status.

In one configuration, ordering computer readable instructions can be in communications with an online retail system such as with a wholesaler or retailer. The ordering computer readable instructions can receive an order or request for a part from the online retail system, search to file the appropriate digital representation and inform the online retailer that the part can be manufactured.

The part may be in the form of a physical part, broken part, and virtual representation 12 such as CAD file, digital photograph, or other formats. In some cases, the file can be either uploaded from the user or retrieved from a local or remote database. The computer readable instructions can determine if the file is sufficiently complete and error free to allow for the file to be transmitted to a rapid manufacturing machine such as a three-dimensional printer. If not, the computer readable instructions can analyze the digital representation of the part and determine what error(s) exist and display the error(s) to a user so that the user can remedy the error(s). The user can modify the digital file, select another digital file, or otherwise remedy the error(s). The advantages of this functionality is that without a proper digital file, the user or purchaser will not order or make the part which results in reduced revenues due to technical digital file errors. It has been reported that at least twenty percent (20%) of the digital file representing parts have one or more error and are not manufactured. The functionality of the present invention allows for the user to remedy these errors, manufacturer the part, which generates revenue for the seller and manufacturer.

For example, the server computer readable instructions can include instructions for determining if error are present in the digital part file. The server computer readable instructions can then determine if the error can be remedied automatically or whether a service provider is needed. If a service provided is needed, the server computer readable instructions can select a service provider from a digital file service provider and transmit the digital part file to the service provided, provide the service provider with the contact information of the user and inform the user that the service provider can offer assistance if needed. Service providers information can be stored in a service provider database and retrieve according the characteristics of the digital part file.

The user or computer readable instructions can select or transmit particular production requirements 14 from pre-determined criteria such as those shown in Table 1 below:

TABLE 1

| | | |
|---|---|---|
| Material | Delivery Time | Color |
| Payment Terms | Trade Terms | Pricing |
| Production Time | Post-Manufacturing | Packaging/Shipping |
| | Processing | |
| Shipping Destination | 3D Scanning | Design Modification |
| Design Analysis | | |

The material requirement is the type of material and therefore physical properties that are desired by the user. The delivery time is the time where the user wishes for the part to be completed and returned. The color is the color of the finished part desired by the user. The payment terms are the terms acceptable to the user such as net 30, 60 day payment terms, or payment plans. Payment terms can include the payment type, case, COD, retainer, credit, and the like. Trade terms can include warranty information, “money back guarantee”, and the like that are desired by the user. Pricing is the total costs desired by the user. Production time is the time it takes to make the part and desired by the user. Post-manufacturing processing is the goods or services that are provided by the manufacturer such as finishing services that are desired by the user. Packaging and shipping are the options for delivery that are desired by the user such as drop shipped to customer, OEM packaging, and the like. Shipping destination is the ability to ship to the actual customer, domestically or internationally. 3D scanning is the ability of the manufacturer to produce a CAD or other electronic file that can be used in the manufacturing process from a physical part from the user. Design modifications are the ability to allow either the user or the manufacturer to modify the original design for purposes such as optimization, improved structural integrity, and the like. Design analysis is the ability of the manufacturer to provide design analysis of the physical part, virtual part of combination provided by the user to the manufacturer.

The part and/or virtual representation and the physical requirements are transmitted to a server 16. The server includes one or more processors that execute computer readable instructions stored on a computer readable medium in communications with the process for performing the steps and providing the functionality shown herein. The server can be cloud based such as with the SaaS model. The server can be one or more physical services or virtual servers. The server can be in communications with a user's computer system, ordering system, procurement system, or online retail system.

There is a plurality of manufacturing machines 18a and 18b that can be directly or indirectly in communications with the server. On one configuration manufacturing machines can include a global communications interface that can communicate directed to the server and provide the service with eh manufacturing machine statistics and criteria. This allows the server to know the status of the machine without human intervention. The manufacturing machine can include an unique address, such as an IP address, and can be uniquely identified by the server. In one configuration, a manufacturer's manufacturing machines 20a and 20b are in communications with a manufacturing server 22 which is in communications with the server. In operations, the server can query the manufacturing machine and receive information about the manufacturing machine that can include machine properties taken from Table 2:

TABLE 2

| | | |
|---|---|---|
| Machine Type | Build Volume Size | Current Material |
| Layer Thickness Min. | Layer Thickness Max. | Speed |
| Resolution | Job Queue/Availability | Status/Capacity |
| Location | Material Type | Cutting Speed |
| No. of Axis | Bits | Manufacturing |
| | | Technology |

Machine type is the type of machine such as 3D printer, CNC, plasma cutter, and the like. Build volume size is maximum and optimal size of a production part that the machine can make. Current material is the currently loaded or readily available raw material used by the machine. Layer thickness min. is the minimum thickness that the machine can produce for each layer. Layer thickness max. is the maximum layer thickness that the machine can produce. Speed is the speed in which the machine operates. Resolution is the physical property of the manufacturing machine that determines precision/tolerance of the machine. For example, in a 3D printer it may be dots per inch and in a CNC machine, if may be the microns or nanometers of a cut. Job queue is the number of jobs that are in line for that machine. Status of the machine can include whether it is in working order, schedule to maintenance, used to capacity, has excess capacity, and the like. Location is the physical location of the machine. Material type if the type of raw material that can be used in the machine. Cutting speed is the speed in which a cut can be made in a material. Number of axis is a property of CNC machines. Bits are the type and properties of bits that can be used for a CNC lathe and the like to provide certain cuts. Manufacturing technology is the method(s) of manufacture available from the machine, which can include hybrid machines such as CNC, laser cutting, and 3D printing in a single machine.

The manufacturing machines can be from various manufactures and can therefore use various communications protocols. For example, 3D printers can be from MakerBot, 3D Systems, ExOne, HP, and others. While there are some efforts to standardize the communications for actually printing a part (e.g. G-Code) communicating other information, as discussed herein, are based upon the language and protocols selected by each 3D printer manufacturer, including proprietary protocols. Therefore, the server can include computer translation computer readable instructions that can translate the commands and the information passed between the server and the manufacturing machine so that the server can be protocol agnostic when communicating with each particular manufacturing machine.

The manufacturing machines can include manufacturing machine computer readable instructions that can determine the status of the manufacturing machine and anticipate when the manufacturing machine will be available for receiving a part request from the server 16. For example, if the manufacturing machines is a 3D printer, the 3D printer can predict when the current manufacturing process will be complete, if there are other jobs queued for that 3D printer and report this information to the server. The server is then informed that the 3D printer will be available to receive a digital part file and can make the part as a time in the future. The manufacturing machine server 22 can include manufacturing server computer readable instructions that can predict when one or machines are available for receiving a digital part file and can make the part. This information can be transmitted to the server.

The server 16 can be in communications with a digital parts database 24 containing a set of digital part files representing physical parts. In one embodiment, when the user uploads a digital part file to server 16, the user can designate whether the file is open or proprietary. If the file is open, the user can agree to provide the file to the database and allow other users to download of use the file to manufacture parts. In one embodiment, a product supplier can upload digital part files for their customer to use if a part or if replacement part needs to be manufactured. For example, a product supplier of cars may elect to upload one or more digital part files to the database that can be used to make replacement parts such as dashboard control knobs. Therefore, customers of the car maker can have replacement parts made for them on demand. The customer could select the digital part file and either request that a part be made and provided to the customer or even potentially modify the part so that a custom part can be made. The digital part file can include areas that are editable and area that are not. For example, a replacement knob may have the area that connects to a stem not editable while the face of the knob could be edited to include lettering, logos, and the like.

In one embodiment, the server 16 can be connected to a third-party database 26 of virtual part files and when a user requests a particular part file, the server can query the digital part database 24 and if the part is not found locally, query the third party database 26 for the part file and if found, provide notification to the user that the part can be made from an existing part file. The server can also be in communications with shipping services system 28. The shipping service can automate the process of providing a physical part to a manufacturer, delivering a manufactured part to a manufacturer for post-process, and deliver the part to a user or user's customer. The server can inform the shipping service system when the manufactured part is ready for shipping and provide to the shipping service system the size, weight, pick-up location, delivery location, and other logistical information to facilitate shipping of the part to the proper location.

Server 16 can also be in communications with a third party clearing house or financial institution system 30 for handling financial transactions. The facilitation of financial transaction can be between the user, retailer, manufacturer, and/or shipper. The user can be the direct customer or can be an intermediary that request the part for the customer. For example, the user can be a car owner that requests a replacement knob or a parts department of a car dealership that requests a replacement knob for the end customer. In this latter case, the user computer readable instructions can first determine if a requested part is in inventory and if so, simply deliver that part to the end customer. Otherwise, if the part is not in inventory, the user computer readable instructions, in communications with the car dealership inventory system, can order the part and communicate with the server to determine when the part will be ready to inform the customer.

For each of the users, manufacturers, and shippers, properties of can be associated with these entities is shown in Table 3:

TABLE 3

| | | |
|---|---|---|
| Material Inventory | Shipping History | Rating |
| Quality | Timeliness | Accuracy |
| Skill | Packaging | Design Analysis |
| Material | Delivery Time | Color |
| Payment Terms | Trade Terms | Pricing |
| Production Time | Post-Manufacturing | Packaging/Shipping |
| | Processing | |
| Shipping Destination | 3D Scanning | Design Modification |
| Machine Type | Build Volume Size | Current Material |
| Layer Thickness Min. | Layer Thickness Max. | Speed |
| Resolution | Job Queue | Status |
| Location | Material Type | Cutting Speed |
| No. of Axis | Bits | Communications/ |
| | | Tracking |
| Digital part file Database | Relationships | Capacity (excess) |

Material inventory is the material that the manufacturer currently has in stock that can be used to make the requested part. Shipping history is a measure of the ability of the manufacturer to have the part shipped to the proper location in a timely manner. Rating is an objective value associated with the manufacturer of shipped part(s) indicating customer satisfaction. Skill is the ability of the manufacturer to make the part in accordance with the user's technical specifications. Packaging is the ability of the manufacturer to properly package the good for shipping including the willingness of OEM to label the packaging. Design Analysis is the ability and desire of the manufacturer to provide design services or to have a third party that provides design services in a manner relatively seamless to the user. Material is the material that the manufacturer can use to make a part. Delivery time is the time when the part will be delivered by the manufacturer. Color is the color that the manufacturer can provide for making parts of a certain material. Payment terms are the terms in which the manufacturer will accept payments. Trade terms include commercial terms such as warranty, returns, and the like. Pricing is the amount charged by the manufacturer.

Production time is the time the manufacturer will take to make the part. Post-manufacturing processing are the goods and services offered by the manufacturer such as finishing, painting, trimming, and the like. Packaging is the packing and shipping services offered by the manufacturer of a third party in cooperation with the manufacturer. Shipping destination is the destinations where the manufacturer or shipper can ship made parts. 3D scanning is the ability of the manufacturer to provide scanning services. A design modification is the ability and the type of design medications provided by the manufacturer or third party in cooperation with the manufacturer. Machine type is the type of manufacturing machine that the manufacturer possesses. The build volume size the volumetric size of a part that can be made with a particular machine. Current material is the raw material that is currently in each machine of the manufacturer. Layer thickness min. is the minimum thickness that a machine can produce for each layer. Layer thickness max. is the maximum layer thickness that a machine can produce. Speed is the speed in which a machine operates. Resolution is the physical property of the machine that determines precision/tolerance. Job queue is the number of jobs that are in line for that machine. Status of the machine can include whether it is in working order, schedule for maintenance, and the like. Location is the physical location of the machine. Material type is the type of raw material that can be used in the machine. Cutting speed is the speed in which a cut can be made in a material. Number of axis is a property of CNC machines. Bits are the type and properties of bits that can be used for a CNC lathe and the like to provide certain cuts. Communications/tracking is the ability of the user to track the process including shipping. Digital part file database is the existence and number of virtual part file in the possession or made available by the manufacturer. Relationship is the relationships of the manufacturer. For example, the manufacturer may be an authorized provider of digital part files or made parts for a particular car maker.

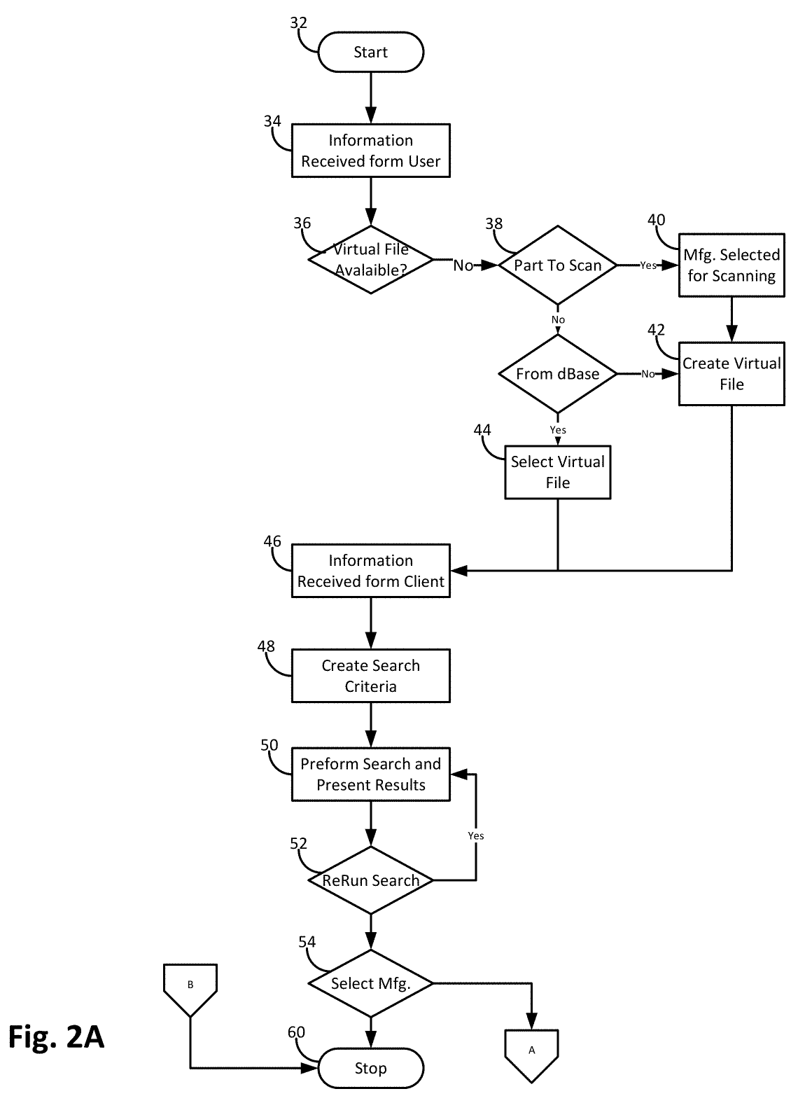

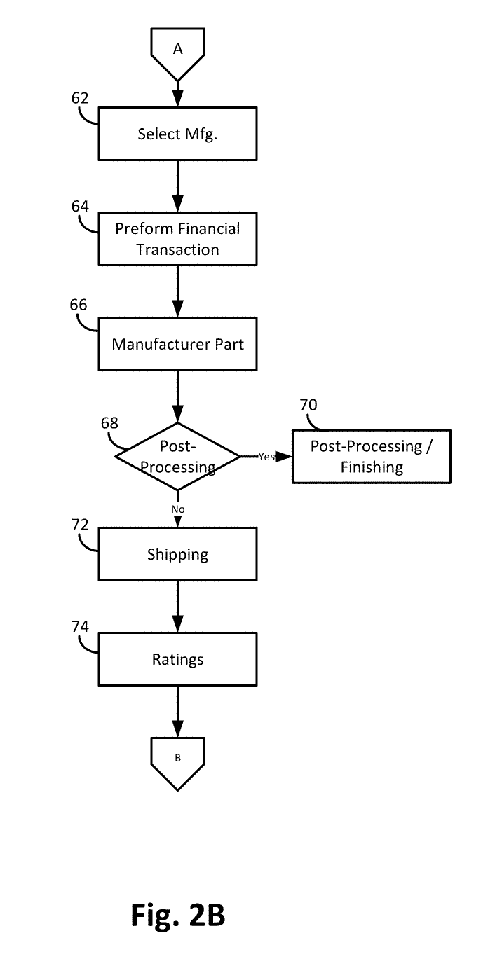

Referring to FIG. 2, the process flow of the invention is shown in more detail. The process starts at 32. The server receives information from the user using a user interface or uploaded information at 34. The user interface can be a display provided to the user by the server (e.g. SaaS model), procurement system, or ordering system. In one configuration, the user information is provided by uploading a part request which can include the digital parts file, to the server, and in one configuration, a customer support representative can enter the information into the server after gathering information from the user. Once the information is received, a determination is made at 36 if the user has a digital part file representing the requested part. If not, a determination is made if the user has a physical part as 38. If so, a manufacturer can be selected that provides 3D scanning to provide a digital file or the user can be provided with other third parties that provide 3D scanning at 40. The user can be instructed to scan the part themselves, take the part to a location where the physical part can be scanned, or otherwise deliver the physical part to a scanning location. Once scanned, the digital parts file can be transmitted to the server. The resulting digital parts file can be created at 42 or selected at 44 from the physical part or from a design package such as CAD.

Once received, the server can then perform an analysis on the file based upon the digital part file and the material and other manufacturing criteria selected at 46. The analysis can include determinations such as whether the wall thickness if optimal for the material selected. In some cases, there is minimum wall thickness recommendation for certain materials. Recommendations can be made for cavities in the design to reduce manufacturing time and costs. Additionally, an analysis can be made to identify a problem area when printing in the 3D printing process, reducing the risks of poor part performance post-manufacturing. For example, if the digital parts file can have missing faces, poor resolutions, disconnected edges and the like, the computer readable instructions can highlight these errors, offer recommended remedies, and allow the user to edit the digital part file. The computer readable instructions can attempt to automatically remedy the file and provide the changes to the user for approval such as completing lines, increasing wall thicknesses, and improving resolution.

At 48, the information received from the user, including the digital part file, can be analyzed and search criteria developed to query available manufacturing machines. Search criteria include criteria from Tables 1 through 3. A search is performed at step 50 and the results presented to the user. The search can be from a dynamic dataset created by manufacturing machines transmitting its availability status to the server. The server can receive the availability status with a manufacturing machine identification and place the manufacturing machine information in a dynamic queue. When the manufacturing machine availability status becomes “busy” or other indicator that the manufacturing machine is unavailable, the server can remove the manufacturing machine from the dynamic queue or mark the manufacturing machine as unavailable. As manufacturing machines transmit availability status to the server, the dynamic queue changes accordingly. The dynamic queue can also receive availability status from the manufacturing server as well as directly from the manufacturing machine. The manufacturing server can aggregate the status of the manufacturing machines and transmit to the server the availability status or one or more manufacturing machines in communications with the manufacturing server. The manufacturing server can transmit to the server in real time or near real time with such as in periodic batches.

In one configuration, when a manufacturing machine sends its availability status to the server and the server determines that the particular manufacturing machine is a possible candidate to making the part, the server can transmit to the manufacturing machine (or manufacturing server) that the manufacturing machine is a candidate and request that the manufacturing machine be placed on a reserved status. By placing the manufacturing machine in a reserved status, the user is given a degree of assurance that the part requested can be made and the time between the request and the order would not result in the manufacturing machine becoming unavailable. In one configuration, if between the time the user requests a part and an order is confirmed, the server computer readable instructions can seek another comparable manufacturing machine and fulfill the order, inform the user that the order may be delayed, or inform the user that the parameters of the order details have changed.

Once the search results are presented to the user, the user can make a determination whether to rerun the search or accept the search results. In this invention, the manufacturers that are available to receive the search results become available and unavailable in real time and when the search is rerun, the user may have access to additional manufacturing resources if certain cases such as a new manufacturer enter the search pool, inventory is updated, and the material is available when previously it was not, a manufacturing machine finishes a job, a price is lower, or any number of changes in respective criteria. If the user wishes to rerun the search, the process returns to 50. If the user does not wish to rerun the search, the user is given the opportunity to select a manufacturer at 54. If the user does not wish to select a manufacturer, the process ends at 60. In one configuration, the search results can be provided to the user and displayed in real time. The server computer readable instructions can retrieve search results from the dynamic queue and provide these to the user when the search results change.

In one embodiment, the criteria described herein is used to determine a best fit option for the customer and/or manufacturer. The criteria can include profit margin and other variables used to select a manufacturer to present to the customer or a customer to present to the manufacturer. For example, the customer can be presented with information that allows the customer to select the most advantageous manufacturer. The manufacturer can be presented with information allowing the manufacturer to select the most advantageous customer. In another embodiment, various options are provided that can be selected and/or ordered by criteria (including profit margin) and presented to the manufacturer. In this embodiment, the selections can be ordered, and the manufacture and/or customer can elect to use one or more from the options provided.

If the user wishes to select the manufacturer, the selection is performed at 62. The financial transaction occurs at 64 and can involve payment terms, manufacturing financing, advance payments, escrow/trust payments, and credit facilities. In one embodiment, the server calculates a percentage of the transaction or other amount and instructs the third party financial institute to deposit this amount into a separate account. The total balance can be debited from the user and credited to the manufacturer. The customer can be notified that the part is ready for shipment and provide payment that can then be divided among the user, manufacturer, shipper, and service provider owning the server. Upon the financial transaction obligation being satisfied, the manufacturer can be notified that it may proceed with making the part at 66. Post-processing requirements are determined at 68 and if needed, post-processing occurs at 70. The part is shipped at 72 and user, customer, and manufacturers have the opportunity to provide feedback representing the user's experience with the manufacturing process at 74.

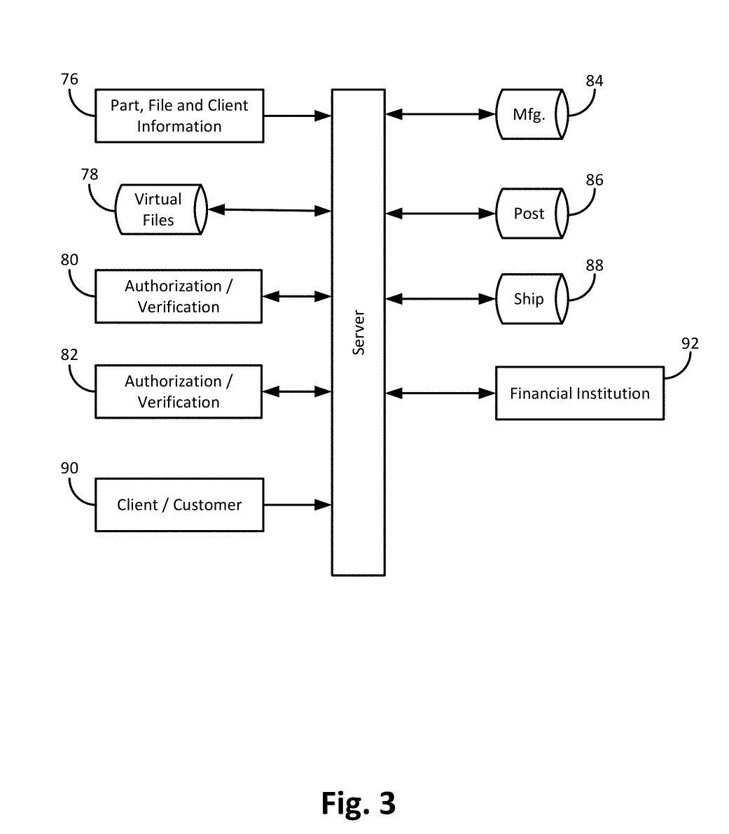

Referring to FIG. 3, the user provides part and other information at 76 that is transmitted to the server. The user's account can be verified or created as needed. If needed, the digital part file is retrieved from the database by the server at 78 and can be transmitted to the user as needed for display, review, approval, modification and the like. The database can be stored on the computer readable medium of the server, stored remotely by the server, or stored by a third party. In one embodiment, the user can be verified at 80 to see if the user is authorized to access digital part files from the database. For example, to verify that the user is the owner of a car so that the car maker authorizes the user to receive digital part files created or provided by the car maker. Once the server receives the digital part file and the part information, the server then performs an analysis to determine operability of the digital part file and provide the user the ability to correct any deficiencies. In one embodiment, the user can be presented with third party software or services that can be used to modify the digital part file at 82.

Once the digital part file is finalized, the server can select matching manufacturers from a database at 84 or dynamic queue and present these matches to the user. The user can then review the matches and may a determination as to which to select. The manufacturer will provide the information and provide a period of time when the ability of the manufacturer to perform the work ends. In this configuration, the manufacturer provides a guarantee where the manufacturing machine is available to make the part.

In one configuration, the user is given a limited amount of time to engage the manufacturer that is equal to or less than the time provided by the manufacturer. In one embodiment, the status of the manufacturer can be updated with changes so that the user can see that the manufacturer is still available or no longer available prior to placing an order. The availability of the manufacturing machine can change on a dynamic, real time basis so that real time updates or near real time updates are provided to the user to avoid unnecessarily delays. For example, a first user can submit a job thereby causing the manufacturer to become unavailable. In one embodiment, the manufacturer can receive an order request and accept or decline the request.

Once the part is manufactured, post-processing may be necessary, and this can be performed by the manufacturer or a third party at 86. The manufacturer can access the shippers at 88 that are authorized by the server to send the manufactured part to a third party post-processing service. The criteria that is used to select the post-manufacturing processing third party can be in response to the user information, manufacturing time, and other criteria. Available shipping service can also be provided to the manufacturer based upon the user information, manufacturing time, and other criteria. Once the part is completed, it is shipped to the user or customer 90.

The financial transaction accompanying the manufacturing can include receiving credit information concerning the user, receiving payment from the user, distributing payment to the manufacturer, post-processing service, and shipper and depositing a portion of the transaction in a separate account.

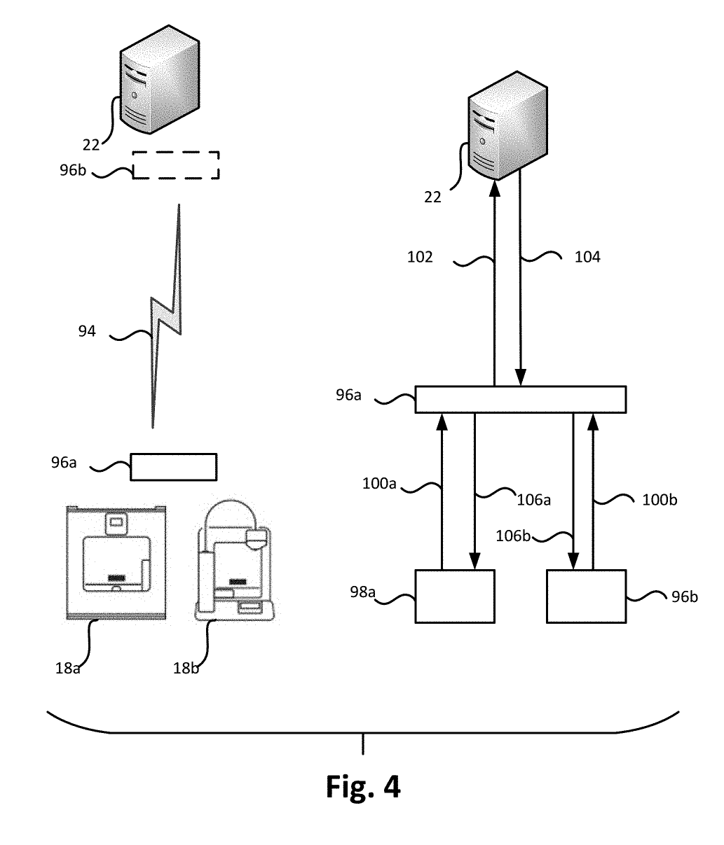

Referring to FIG. 4, 3D printer 18a and 18b can automatically transmit information to server 16 or manufacturer server 22 through a communications connection 94 that can be wired or wireless. Information from the individual 3D printer, or other device, that is transmitted to the server 16 or manufacturing server 22 can take on various format as there are no industry standards. For examples, some printers require “OK” or “ACK” between transition lines and will wait to receive such information prior to sending additional information to the server. Some require checksums between lines. Therefore, there is a translator 96a that can be inserted between the device and the server or manufacturing server. In one embodiment, the translator is located at the site of the printer or other device and can include hardware, software, or both. In one embodiment, the translator is a set of computer readable instructions disposed between the printer or other device and the server. In one embodiment, the translator 96b is disposed at the server 16 location and can be hardware, software, or both. Using the translator allows the server 16 to communicate with printers and other devices without the need to translate each server command or message and information or data received from each printer or device. The specific and potentially proprietary communications information 98a and 98b are transmitted from the printer or device to the translator. The translator converter can translate communications 100a and/or 100b from the original language and syntax to a server syntax 102. The server syntax is transmitted to the server so that the server can receive the information described herein from the various printer or devices in a single consistent format. If the server wishes to transmit information to the printer or other devices, the transmission 104 can be sent to the translator. The translator can convert the transmission to the respective syntax and protocols 106a and 106b and these can be sent to the respective printer or devices. In one embodiment, a remote network or service can be disposed between the printer or other device and com-converter or otherwise in communications with a remote server or network attached to the printer or other device.

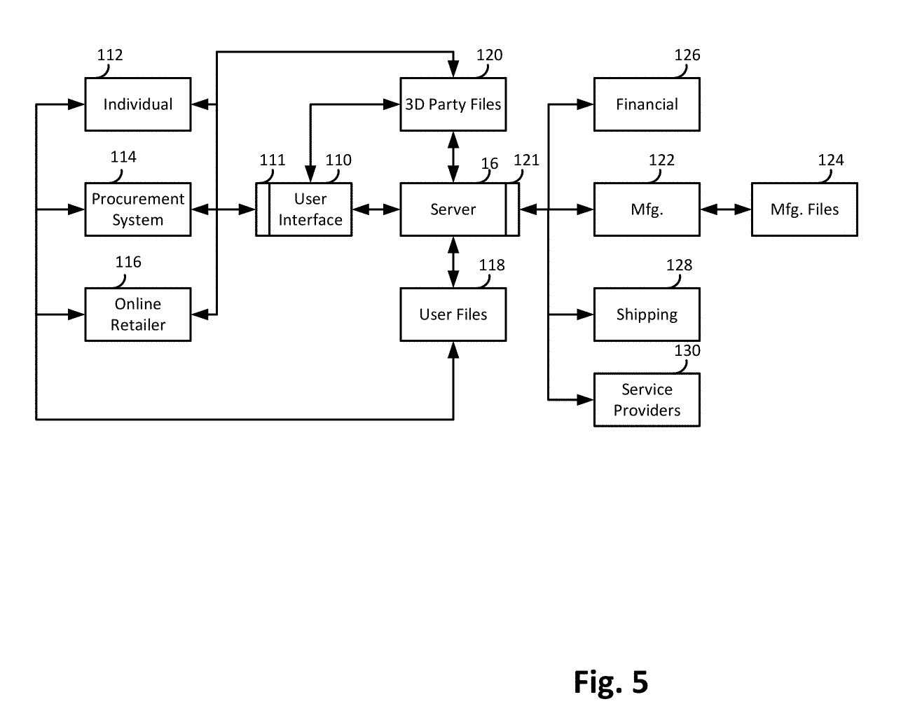

Referring to FIG. 5, a schematic of the data flow and functionality of the invention is shown. There can be a user interface 110 that can serve as an access point to the server 16. The user interface can include a user translation module 111 that can translate the syntax or protocol from the individual system, procurement system or the online retailer to one understood by the server. The user interface can be a display that is provided to an individual computer system 112 such a webpage under a SaaS model or a local screen with user computer readable instructions stored locally at the individual computer system 112 or a module integrated into an existing system at the individual computer system 112. For example, the individual computer system could have a plug-in for a CAD system that can integrated with the user interface so that when a digital part file is created using the CAD, the plug-in allows the digital part file to be transmitted to the server 16 so that ordering information can be provided back to the individual computer system 112. A procurement system 114 can interface with the user interface to allow a user of the procurement system to select digital parts files and order parts. This integration also can be the process of selection of the digital part file transparent as the user of the procurement system can simply select a part to be ordered and the computer readable instructions of the server 16 can locate the digital part file and transmit it to the appropriate manufacturing as stated herein. The procurement system can also automatically order parts by using computer readable instructions that can maintain minimum inventories, adjust to seasonal forecasts, and the like. The procurement system can communicate with an interface 116 so that the order information from the procurement system can be translated without necessarily changing the syntax and protocols of the part request/order information from the procurement system. The user interface can also communicate with an online retailer system 116 so that when a user of the online retailer system orders a part, the part request can be transmitted to the server, digital par file transmitted to the manufacturer, the part made, and delivered to the user. A server translation 121 module can translate syntax and protocols between the server and the manufacturing server or manufacturing machines. The digital part files can be user files 118 that are used can be provided by the user or can be third party files 120 provided by third parties. The digital part files can be pre-existing as user files or third-party files, modified user or third-party files, or new files created and/or uploaded databases accessible by the individual, procurement system, online retailer, or server. For example, the online retailer may have a database of digital part files representing parts that it sells, and the procurement system have a database of digital part files for parts that is orders.

Once the server receives part requests/order information, it can discover which manufacturer can provide the part that is compatible with the desire part criteria and transmit the digital file or order information to the manufacturer 122. Some of the manufacturers can also have their own digital parts file database 124 so that its particular ability to make certain parts from its digital part file can be transmitted to the server assisting the server in the selection process. The server 16 can also communicate with financial system 126, and shipping or logistics system 128. Therefore, the individual user, procurement system, or online retailer can allow a part to be ordered and the section of the proper digital part file, the best manufacturing source according the part, and order criteria can be made and shipped to the user with the appropriate financial arrangement between the parties in a seamless, automated fashion.

In the event that the digital part file has errors and a service provided is contacted to remedy the errors, the service provider 130 can be selected from a database of service providers, transmitted the digital part file containing the errors to the service provider with the user's contact information allowing the user and service provider to work together to remedy the errors. The remedied digital part file can then be provided to the server or manicuring machine so that the part can be made. The service providers can submit information to the server such as years or experience, CAD system used, digital files user, industry experience, CAD experience, customer rating, availability, rates, turn around time, and the like. This information can be provided to the user to assist the user in selecting a service provider to assist with a digital part file having errors. The remedied digital part file can be stored at the server, user, third party or service provider for subsequent use.

The computer readable instructions can also aggregate order and parts so that the manufacturer can be presented with a group of parts to manufacturer making the manufacturing process more efficient. The group of parts can be aggregated by material type, size, shipping address, manufacturing time, machine available, and the like. The server can communicate with the shipping system and determine the number of parts to be placed in a single container. This is advantageous when parts can be aggregated in standard sized shipping container to minimize shipping costs per item and to above larger than standard shipping containers which can increase shipping costs.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

Unless specifically stated, terms, and phrases used in this document, and variations thereof, unless otherwise expressly stated, should be construed as open ended as opposed to limiting. Likewise, a group of items linked with the conjunction “and” should not be read as requiring that each one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements, or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A system for aggregating disparate remote rapid manufacturing resources for fulfillment of manufactured parts comprising:
a user computer system in communications with a server;
a set of user computer readable instructions executed on the user computer system for receiving a part request from a group consisting of an individual, a procurement system, an ordering system or any combination thereof; translating the part request into a syntax usable by a set of server computer readable instructions; and receiving order status information from the set of service computer readable instructions representing that the requested part can be made;
a server in communications with a manufacturing system and a shipping system; and,
the set of server computer readable instructions executed on the server that can receive the part request from the user computer system, determine if the part request is accompanied by a digital part file, if not request a digital part file from a set of digital part files and receive the digital part file from the set of digital part files, receive manufacturing machine status information from a dynamic queue of available manufacturing machines suitable to make the requested part and representing the ability to physically make the requested part according to part request, transmit the manufacturing machine status information to the user computer system for displaying the status information to the user, receive an order confirmation from the user computer system according to the manufacturing machine status information, transmit the order confirmation to the manufacturing system, receive a confirmation that the part has been manufactured from the manufacturing system, transmit shipping information to a shipping system representing logistics information for shipping the part to user and transmit the shipping information to the manufacturing system so that the manufactured part can be shipped to the user.

2. The system of claim 1 wherein the manufacturing machine is in communications with the server and includes a set of manufacturing computer readable instructions that periodically transmits the manufacturing machine status information of the manufacturing machine to the server.

3. The system of claim 2 wherein the set of manufacturing computer readable instructions includes instructions that transmits a further forecast of the manufacturing machine representing when in the future the manufacturing machine will be able to make the requested part.

4. The system of claim 3 wherein the set of server computer readable instructions include instructions for receiving the manufacturing machine status information from the manufacturing machine and translating a manufacturing machine syntax of the manufacturing machine status information to a server syntax.

5. The system of claim 1 including:
a manufacturing server having manufacturing computer readable instructions;
the set of server computer readable instructions includes instructions for transmitting a reservation request to a manufacturing server representing that one manufacturing machines associated with the manufacturing server is a candidate to receive an order confirmation; and,
the manufacturing computer readable instructions includes instructions preventing an additional manufacturing job from being assigned to the manufacturing machine for a predetermined period of time.

6. The system of claim 5 wherein the set of server computer readable instructions includes instructions for transmitting to the manufacturing server release instructions representing that the manufacturing machine was not selected for the manufacturing the requested part and can be released to perform an additional job.

7. The system of claim 1 wherein the dynamic queue receives manufacturing machine status information in real-time and the set of server computer readable instructions transmits to the user computer system the manufacturing machine status information in real-time.

8. The system of claim 1 wherein the manufacturing machine status information includes an engage time representing the time in which the manufacturing machine will be available to make the requested part.

9. The system of claim 8 wherein the server computer readable instructions include instructions for transmitting an order confirmation time representing the time limit in which the user can select the manufacturing machine and the order confirmation time is less than the engage time.

10. The system of claim 1 wherein the set of server computer readable instructions include instruction for determine if the digital part file selected to make the requested part is capable of being used by the manufacturing machine, and if not, generating error correction information representing proposed correction to the digital part file and transmitting the error correction information to the user computer system.

11. A system for aggregating disparate remote rapid manufacturing resources for fulfillment of manufactured parts comprising:
a user computer system in communications with a server;
a set of user computer readable instructions executed on the user computer system for receiving a part request; receiving order status information from a set of server computer readable instructions representing that the requested part can be made;
a server in communications with a manufacturing system and a shipping system; and,
the set of server computer readable instructions, executed on the server, includes instructions that can receive a part request from the user computer system, determine if the part request is accompanied by a digital part file, if not request a digital part file from a set of digital part files and receive the digital part file from the set of digital part files, receive manufacturing machine status information from a dynamic queue of available manufacturing machines suitable to make the requested part and representing the ability to physically make the requested part according to part request, transmit the manufacturing machine status information to the user computer system for displaying the status information to the user, receive an order confirmation from the user computer system according to the manufacturing machine status information, transmit the order confirmation to the manufacturing machine, receive confirmation that the part has been manufactured from the manufacturing machine, transmit shipping information to a shipping system representing logistical information to ship the part to user and transmit the shipping information to the manufacturing machine so that the manufactured part can be shipped to the user.

12. The system of claim 11 including a procurement system having procurement computer readable instructions for determining if the number of parts in an inventory drops below a predetermine level and if so, automatically sending an order result to the server, receiving receive manufacturing machine status information, selecting a manufacturing machines according to the manufacturing machine status information and transmitted an order confirmation to the server.

13. The system of claim 12 wherein the procurement computer readable instructions include instructions for updating a set of properties associated with the manufacturing machine selected.

14. The system of claim 11 including an ordering system having ordering computer readable instructions for receiving a part request from a user, receiving manufacturing machine status information, selecting a manufacturing machine according to the manufacturing machine status information and transmitted an order confirmation to the server so that the manufacturing machine can be instructed to manufacturer the part.

15. The ordering system of claim 14 wherein the ordering computer readable instructions include instructions for displaying to the user to period of time that the manufacturing machines are available for making the requested part.

16. The system of claim 14 wherein the set of ordering computer readable instructions includes instructions for aggregating part requests and transmit the aggregated parts requests to a particular manufacturing machine according to the manufacturing machine's machine properties.

17. A system for aggregating disparate remote rapid manufacturing resources for fulfillment of manufactured parts comprising:
a server in communications with a manufacturing machine; and,
the set of server computer readable instructions, executed on the server, includes instructions that can receive a part request from a user computer system, receive manufacturing machine status information from a dynamic queue of available manufacturing machines suitable to make the requested part, transmit the manufacturing machine status information to the user computer system, receive an order confirmation from the user computer system, transmit the order confirmation to the manufacturing machine, and receive confirmation that the part has been manufactured from the manufacturing machine.

18. The system of claim 17 wherein the set of server computer readable instructions include instruction for determining if the digital part file selected to make the requested part is capable of being used by the manufacturing machine, and if not, selecting a service provider that can assist with remedying the errors and transmitting the digital part file and a user contact information to the service provider.

19. The system of claim 17 wherein the set of manufacturing computer readable instructions includes instructions that transmits a further forecast of the manufacturing machine to be able to make the requested part.

20. The system of claim 17 wherein the set of server computer readable instructions includes instructions for aggregating part requests and transmitting the aggregated parts requests to a particular manufacturing machine according to the manufacturing machine's machine properties.
